(19) United States
(12) Patent Application Publication
(10) Pub. No.: US 2010/0147689 A1
(43) Pub. Date: Jun. 17, 2010

(54) METHOD FOR MODIFYING SURFACE OF ALUMINUM OXIDE AND ELECTROOSMOSIS PUMP AND ELECTRIC POWER GENERATOR USING MODIFIED ALUMINUM OXIDE MEMBRANE

(75) Inventors: Yu-Feng Chen, Hsinchu City (TW); Yen-I Chou, Hsinchu City (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/473,255

(22) Filed: May 27, 2009

(30) Foreign Application Priority Data
Dec. 17, 2008 (TW) TW097149116

(51) Int. Cl. B01D 61/42; C01F 7/02

(52) U.S. Cl. 204/518; 423/625

(57) ABSTRACT

The invention provides a method for modifying a surface of aluminum oxide. Aluminum oxide is contacted with a hydrogen peroxide aqueous solution having 5-70 volume % of hydrogen peroxide for 20 minutes to 3 hours. The invention also provides an electroosmosis pump and electric power generator having a porous aluminum oxide membrane modified by the above method.

### CROSS REFERENCE TO RELATED APPLICATIONS

This Application claims priority of Taiwan Patent Application No. 97149116, filed on Dec. 17, 2008, the entirety of which is incorporated by reference herein.

### BACKGROUND OF THE INVENTION

1. Field of the Invention

The present invention relates to a method for modifying a surface of aluminum oxide, and particularly relates to a method for modifying a surface of aluminum oxide for arising a surface potential, and an electroosmosis pump and electric power generator using the modified aluminum oxide membrane for improving flow rate or efficiency.

2. Description of the Related Art

The electrokinetic effect utilize charge distribution in a liquid, referred to as the electric double layer (see FIG. 1), resulted by an ionization or dissociation of surface groups in an interface between the solid and the liquid. The electric double layer is quit influential when a size of a fluid channel is small to some value. At this condition, the physical phenomenon occurred in the fluid due to external force commonly comprise electroosmosis, electrophoresis, streaming potential, and sedimentation potential. Electroosmosis and streaming potential characteristics are applicable for an electroosmosis (EO) pump and a power generator, respectively. The EO pump operates flow by applying an external electric force. The power generator generates electric power by applying an external pressure force. FIG. 1 shows the charge distribution of an electric double layer. When the surface charge (or potential) of a solid is increased, the ionization degree of a fluid is increased, thus improving working efficiency of an EO pump and power generator. For the EO pump, according to the theoretical analysis [1] for example, the volume flow rate of the electroosmotic flow Q in a single tube is:

$$Q = - \frac{ψ ɛ ζ {AV}_{eff}}{μ L} f , \qquad ( 1 )$$

where f is

$$f = {\int }_{0}^{a} ( 1 - \frac{ϕ}{ζ} ) \frac{2 r}{{a}^{2}} d r , \qquad ( 2 )$$

ψ is the porosity, A is the cross-section area, a is the membrane pore radius, μ is the viscosity, L is the membrane thickness, r is the dielectric coefficient of electrolyte, ζ is the zeta potential, V_{eff} is the effective voltage across membrane, and φ is the potential in the pore.

According to the analysis of Yao et al. (2003) [2], the potential inside the pore is φ=ζI₀(r*)/I₀(r*), where I₀ is a zeroth order Bessel function, r*=r/λ, a*=a/λ, and λ is a Debye length [1]. The Debye length is assumed to be a constant at a constant electrolyte concentration, thus obtaining the result that the flow rate is proportional to the zeta potential, as shown in the Equation (3):

Q≈ζ (3).

From the Equation (3), it is understood that the zeta potential is an important parameter for EO pump efficiency.

Moreover, for the power generator, for example, a relationship of an additional force (ΔP), and yield electric potential (Vₛₜᵣ) and electric current (Iₛₜᵣ) is shown in the following Equations[10]:

$${V}_{str} = Δ P \frac{ɛ {ɛ}_{0} ζ}{η} \frac{1}{{K}_{L}} ( 1 - G ) ; \qquad ( 4 )$$

and

$${I}_{str} = Δ P \frac{ɛ {ɛ}_{0} ζ}{η} \frac{A}{L} ( 1 - G ) . \qquad ( 5 )$$

Where K_{L} is the conductivity of channel, and G is defined as

$$G = \frac{tanh κ h}{κ h} .$$

κ=1/λ is Debye-Hückel parameter

Similarly, from the Equation (4), it is understood that the zeta potential is also an important parameter for power generator efficiency. Therefore, for the power generator, the yield potential and electric current, in other words, the power generator efficiency, can be improved by increasing the zeta potential (ζ).

Conventional EO pumps and potential generators have low efficiency, far less than 1%. For example, some researchers improved EO pump efficiency by increasing applied voltage (1.3% at 2kV of Zeng et al. (2001) [3]; 5.6% at 1 kV of Reichmuth et al. (2003) [4]; 2.2% at 6 kV of Wang et al. (2006) [5]). However, this kind of EO pump is not suitable to be integrated with a NEMS/MEMS (Zeng et al (2001) [3], Takamura et al. (2003) [6], Yao et al. (2003) [2], Brask et al. (2005) [1]). In addition, other methods, such as modifying a PH value of a solution, or a thickness, porosity, or tortuosity of a porous membrane, were used for improving efficiency (Yao et al. (2006) [7]; Vajandar et al. (2007) [8]). However, results were not optimal.

Generally, in low concentration electrolyte, the zeta potential of aluminum oxide is about 60 mV (Hunter et al. (1981) [9]), and silicon oxide is about −100 mV (Yao et al. (2006) [7] and Vajandar et al. (2007) [8]). Therefore, some researchers (Vajandar et al. (2007) [8]) disclosed modifying the surface of the aluminum oxide membrane with silicon dioxide for improving pump efficiency. This technology is provided only to change membrane surface charge from positive (aluminum oxide membrane) to negative (silicon oxide membrane) charge when dipped membrane in a solution of pH value <8. The absolute zeta potential can not be significantly increased. Thus the pump efficiency was still extremely low (far less than 0.1%).

### REFERENCE

[1] Brask A, Kutter J P, and Bruus H (2005) Long-term stable electroosmosis pump with ion exchange membranes. Lab on a Chip 5:730-738.
[2] Yao S, Hertzog D E, Zeng S, Mikkelsen Jr. J C, and Santiago J G (2003b) Porous glass electroosmosis pumps: design and experiments. J. Colloid Interface Sci. 268:143-53.
[3] Zeng S L, Chen C H, Mikkelsen J C and Santiago J G (2001) Fabrication and characterization of electroosmotic micropumps. Sens. Actuators B 79: 107-14.
[4] Reichmuth D S, Chirica G S, and Kirby B J (2003) Increasing the performance of high-pressure, high-efficiency electrokinetic micropumps using zwitterionic solute additives. Sens. Actuators B 92: 37-43.
[5] Wang P, Chen Z, and Chang H C (2006) A new electro-osmotic pump based on silica monoliths. Sens. Actuaors. B 113:500-509.
[6] Takamura Y, Onoda H, Inokuchi H, Adachi S, Oki A, and Horiike Y (2003) Low-voltage electroosmosis pump for stand-alone microfluidics devices. Electrophoresis 24:185-192.
[7] Yao S, Myers A M, Posner J D, Rose K A, and Santiago J G (2006) Electroosmosis pumps fabricated from porous silicon membranes. J. Microelectromech. Syst. 15( 3): 717-728.
[8] Vajandar S K, Xu D, Markov D A, Wikswo J P, Hofmeister W and Li D (2007) SiO2-coated porous anodic alumina membranes for high flow rate electroosmosis pumping. Nanotechnology 18: 275705.
[9] Hunter R J (1981) Zeta Potential in Colloid Science: Principles and Applications, Academic Press Inc., London.
[10] Burgreen D, and Nakache F R (1964) Electrokinetic Flow in Ultrafine Capillary Slits, J. Phys. Chem. 68:1084-1091

### BRIEF SUMMARY OF INVENTION

A detailed description is given in the following embodiments with reference to the accompanying drawings.

The invention provides a method for modifying a surface of aluminum oxide. In an embodiment of the method, aluminum oxide is contacted with a hydrogen peroxide aqueous solution having 5-70 volume % of hydrogen peroxide for 20 minutes to 3 hours.

In another embodiment of the method, aluminum oxide is contacted with a hydrogen peroxide aqueous solution. After the hydrogen peroxide solution contact step, the aluminum oxide is contacted with an APS-((3-Aminopropyl)trimethoxysilane) or MPTS-((3-Mercaptopropyl)trimethoxysilane)acetone solution, which APS or MPTS is dissolved in acetone, to modify the surface of the aluminum oxide. The contacting time is 1 hour to 12 hours. The volume fraction of APS or MPTS:acetone of the APS- or MPTS-acetone solution is 0.5:60 to 5:100.

The invention provides an electroosmosis pump. A nano-porous aluminum oxide membrane having at least one nano-pore for transferring fluid and modified by the method as described above is provided. Two electrodes are disposed on two opposite sides of the nano-porous aluminum oxide membrane and connected with a power supply for applying potential and causing electroosmotic flow of fluid in the nano-pore of the nano-porous aluminum oxide membrane.

The invention also provides an electric power generator. A nano-porous aluminum oxide membrane having at least one nano-pore for a flow channel and modified by the method as described above is provided. A fluid supplying system is provided for supplying a fluid flowing through the nano-pore, causing a potential between the two opposite sides of the nano-porous aluminum oxide membrane.

### BRIEF DESCRIPTION OF DRAWINGS

The present invention can be more fully understood by reading the subsequent detailed description and examples with references made to the accompanying drawings, wherein:

FIG. 1 shows the charge distribution of an electric double layer.

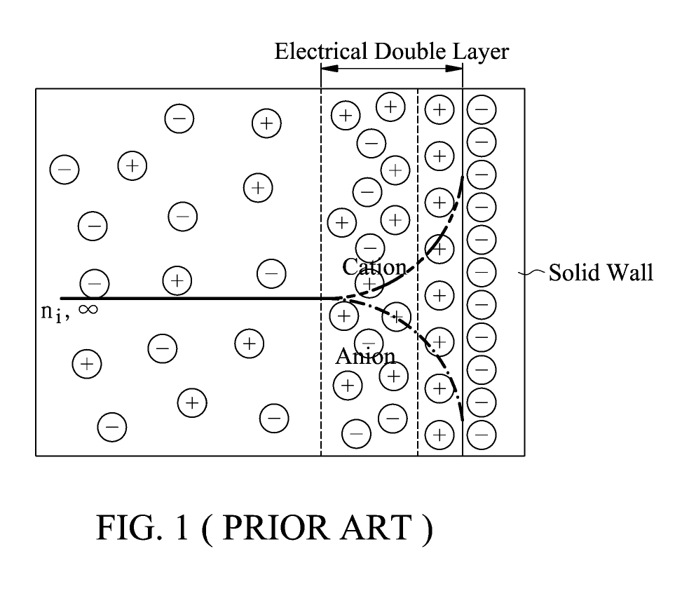

FIG. 2 is FTIR spectrums of an APS modified aluminum oxide membrane.

FIG. 3 is FTIR spectrums of MPTS modified aluminum oxide membrane.

FIG. 4 is a schematic diagram of an electroosmosis pump of the invention.

FIG. 5 is a diagram of a working region of electroosmosis pumps

FIG. 6 illustrates the relationship between the input voltage and yield flow rate of electroosmosis pumps.

FIG. 7 is a schematic diagram of an electric power generator of the invention.

### DETAILED DESCRIPTION OF INVENTION

The present invention provides a method for modifying a surface of aluminum oxide, comprising making aluminum oxide contact with hydrogen peroxide, 3-aminopropyltriethoxysilane (APS), or 3-Mercaptopropyl trimethoxysilane (MPTS) to modify the surface of the aluminum oxide to get a higher surface potential.

In one embodiment, the method comprises making the aluminum oxide contact with a hydrogen peroxide aqueous solution. The hydrogen peroxide aqueous solution may have about 5-70 volume % of hydrogen peroxide. The contacting time may be about 20 minutes to about 3 hours.

In another embodiment, the method comprises, after the hydrogen peroxide aqueous solution contact step, making the aluminum oxide contact with an APS or MPTS containing solution to modify the surface of the aluminum oxide. The contacting time may be about 1 hour to about 12 hours. A solvent of the APS or MPTS containing solution may be acetone. A volume fraction of APS or MPTS:acetone may be about 0.5:60 to about 5:100. The present invention uses an organic molecule modifying method, coating organic molecule onto the aluminum oxide surface, and decomposing and charging the surface function group so as to increase the surface potential (zeta potential) of the material. In the organic molecule, in addition to the head group anchor which bonds to the substrate (membrane), the tail group has a plurality of protonized or de-protonized function groups so that the surface potential of aluminum oxide can be increased.

After contact with the MPTS containing acetone solution, the aluminum oxide can further contact with a hydrogen peroxide aqueous solution. The hydrogen peroxide aqueous solution may have hydrogen peroxide of about 5-70 volume %. The contacting time may be over about 20 hours.

The method of the invention may further comprise drying the aluminum oxide. The drying step may be performed after the hydrogen peroxide solution contact step. The drying temperature may be about 40 to about 100. The drying pressure may be about 10 cmHg to about 50 cmHg. In one embodiment, the drying step may be performed between the hydrogen peroxide aqueous solution contact step and the APS or MPTS containing solution contact step. In one alternative embodiment, the drying step may be performed after the APS or MPTS containing solution contact step.

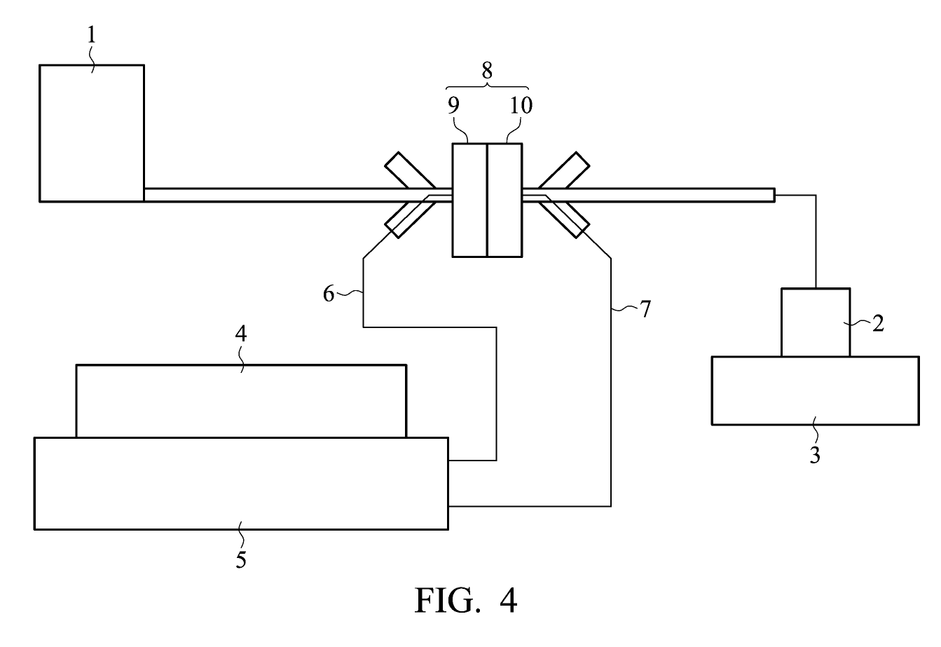

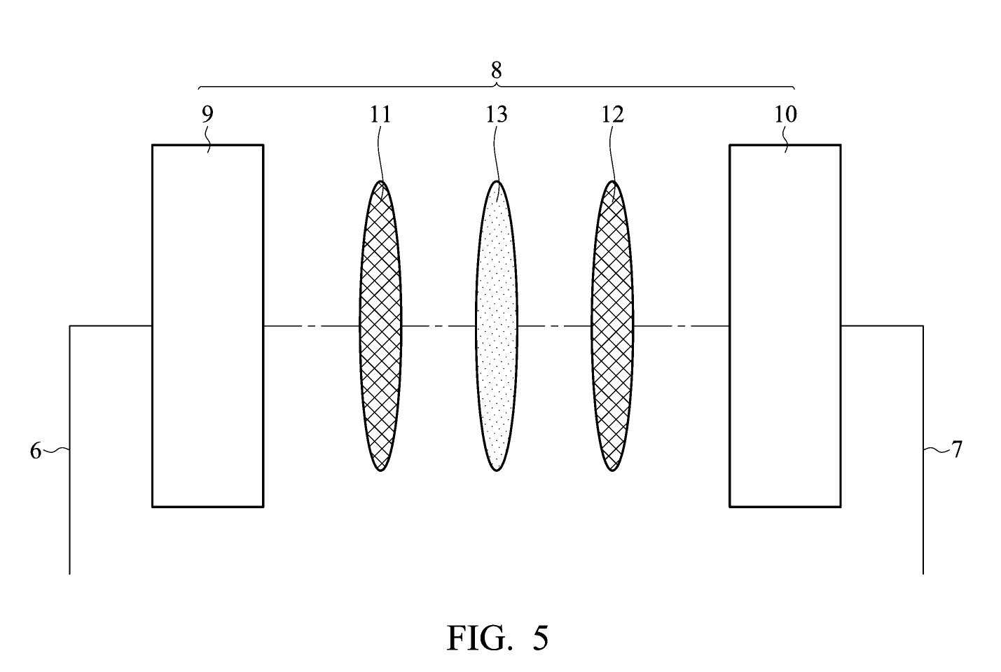

The surface-modified porous aluminum oxide membrane modified by the method of the invention may be applied in an electroosmosis pump. FIG. 4 shows a schematic diagram of an electroosmosis pump of the invention. FIG. 5 is a diagram of a working region 8 of the electroosmosis pump of the invention. In the electroosmosis pump, the surface-modified porous aluminum oxide membrane 13 has least one pore for transferring fluid. The pore has nano-scale, preferably. Two electrodes 11 and 12 are disposed on two opposite sides of the porous aluminum oxide membrane 13. A power supply may input potential to the electrodes 11 and 12 so as to cause electroosmotic flow of fluid in the nano-pore of the porous aluminum oxide membrane 13. The electrode 11 and 12 may be meshed metal, such as silver, gold, platinum, or stainless steel. The present invention, without changing the fluid channel size, increases the surface potential (zeta potential) of the membrane or fluid channel by coating molecules onto the membrane surface, and decomposing and charging the surface function group of the molecules. It is understood from Equation (3) that since the flow rate of the electroosmosis pump is proportional to the zeta potential, the flow rate is increased when the zeta potential is increased. Therefore, when compared to an electroosmosis pump using unmodified aluminum oxide membrane, the electroosmosis pump using the surface-modified porous aluminum oxide membrane of the invention has a higher working efficiency.

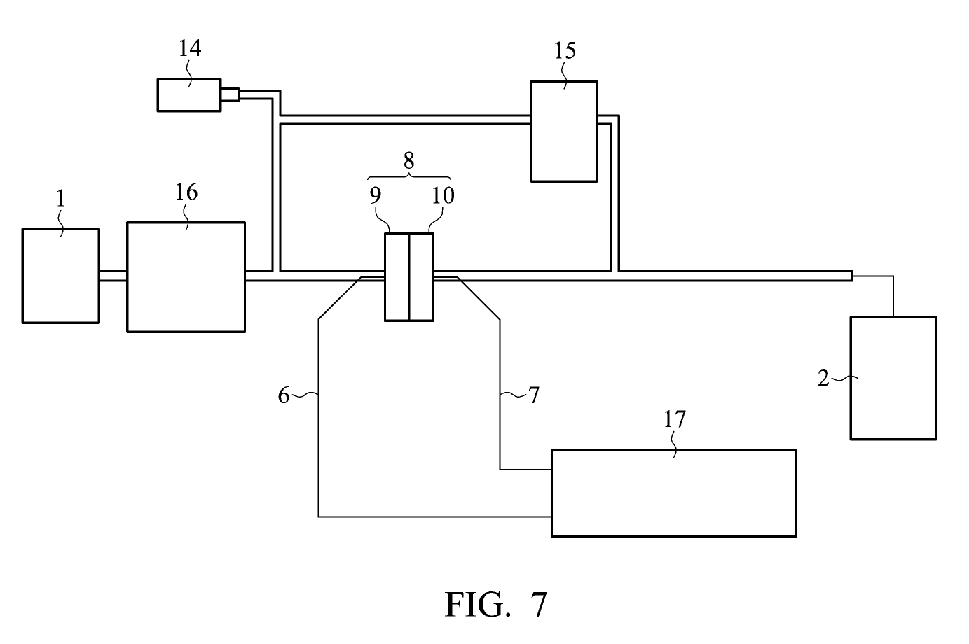

The surface-modified porous aluminum oxide membrane modified by the method of the invention may be also applied in an electric power generator. FIG. 7 shows a schematic diagram of an electric power generator of the invention. FIG. 5 is a diagram of a working region 8 of the electric power generator. In the electric power generator, the surface-modified porous aluminum oxide membrane 13 has least one pore for a flow channel. The pore has nano-scale preferably. The electric power generator comprises a fluid supply system (such as reservoir 1 and drive pump 16) to supply fluid flowing through the pore of the aluminum oxide membrane 13 so as to cause a potential between the two opposite sides of the porous aluminum oxide membrane 13, thereby generating electric power. Accordingly, from Equation (4), it is understood that the yield electric potential of the electric power generator is increased when the zeta potential is increased. Therefore, when compared to an electric power generator using unmodified aluminum oxide, the electric power generator using the surface-modified porous aluminum oxide membrane of the invention has a higher working efficiency.

The following description is of the best-contemplated mode of carrying out the invention. This description is made for the purpose of illustrating the general principles of the invention and should not be taken in a limiting sense. The scope of the invention is best determined by reference to the appended claims.

### COMPARATIVE EXAMPLE 1

An unmodified porous aluminum oxide membrane with pores having diameter of 200 nm was provided.

### EXAMPLE 1

An unmodified porous aluminum oxide membrane like Comparative Example 1 was dipped in H₂O₂ aqueous solution with volume concentration of 30% for 2 hours, and then washed by de-ionized water several times. Next, the aluminum oxide membrane was baked under a temperature of 100 and a pressure of 26 cmHg for over 6 hours.

### EXAMPLE 2

An unmodified porous aluminum oxide membrane like Comparative Example 1 was dipped in H₂O₂ aqueous solution with volume concentration of 30% for 2 hours, and then washed by de-ionized water several times. The aluminum oxide membrane was baked under a temperature of 100 and a pressure of 26 cmhg for over 6 hours. Next, the aluminum oxide membrane was dipped in an APS/acetone solution with volume fraction of 1/100 for 3 hours, and then washed by acetone several times. Then, the aluminum oxide membrane was baked under a temperature of 100 and a pressure of 26 cmHg for over 12 hours.

### EXAMPLE 3

An unmodified porous aluminum oxide membrane like Comparative Example 1 was dipped in H₂O₂ aqueous solution with volume concentration of 30% for 2 hours, and then washed by de-ionized water several times. The aluminum oxide membrane was baked under a temperature of 100 and a pressure of 26 cmhg for over 6 hours. Next, the aluminum oxide membrane was dipped in an APS/acetone solution with volume fraction of 1/100 for 3 hours, and then washed by acetone several times. Then, the aluminum oxide membrane was baked under a temperature of 100 and a pressure of 26 cmHg for over 12 hours. Next, the aluminum oxide membrane was dipped in H₂O₂ aqueous solution with volume concentration of 30% for over 1 day for oxidation, and then dried by nitrogen.

### Contact Angle Test

The unmodified (Comparative Example 1) and surface-modified (Examples 1-3) aluminum oxide membrane was analyzed by contact angle change. The results are shown in Table 1.

TABLE 1
Contact angle of aluminum oxide membrane

| number | Contact angle (degree) |
|---|---|
| Comparative Example 1 | <5 |
| Example 1 | <5 |
| Example 2 | 53 |
| Example 3 | 18 |

Accordingly, the contact angle of the hydrophilic unmodified aluminum membrane was smaller than 5°. After treating with H₂O₂, the contact angle of the membrane was still smaller than 5°. When the membrane was further modified by APS, the contact angle was increased to 53° and became hydrophobic due to the amino-group of the APS. The result also shows that APS was indeed coated on the surface of the aluminum oxide membrane. In the modifying process with the MPTS and oxidation, the contact angle was changed from 83° to 18°. Due to the hydrophobic mercapto-group, the contact angle was increased from 5° to 83°after MPTS modifying process. Meanwhile, after oxidation process, the hydrophobic mercapto-group as changed to the hydrophilic sulfonic acid-group (SO₃H-group), thus, the contact angle was changed from 83° to 18°.

Fourier Transform Infrared spectroscopy (FTIR) Analysis

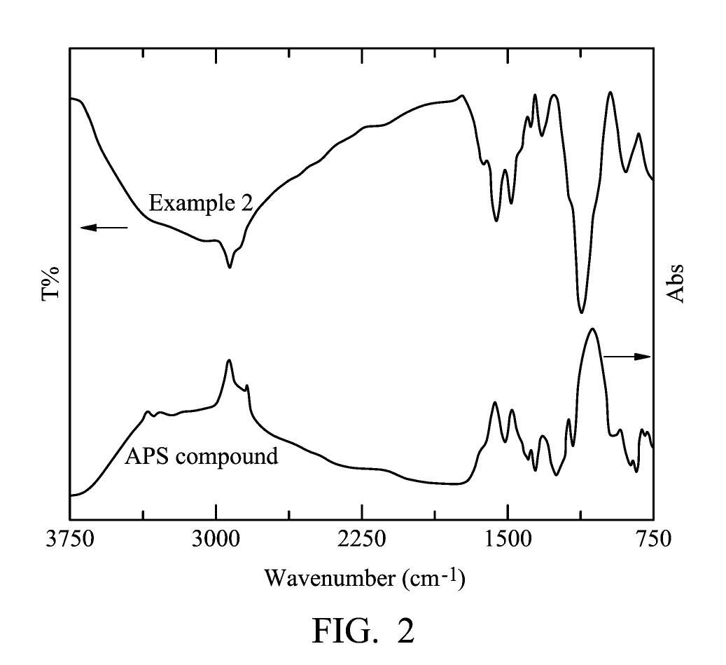

FIG. 2 shows FTIR spectrums of the surface-modified aluminum oxide membrane of Example 2 and APS compound in a KBr solution.

FIG. 2 illustrates that Example 2 has an absorption peak at a position of 1563 cm⁻¹ related to assignment of the NH₂ of the APS. Thus, reaffirming that the APS was coated onto the surface of AAOM.

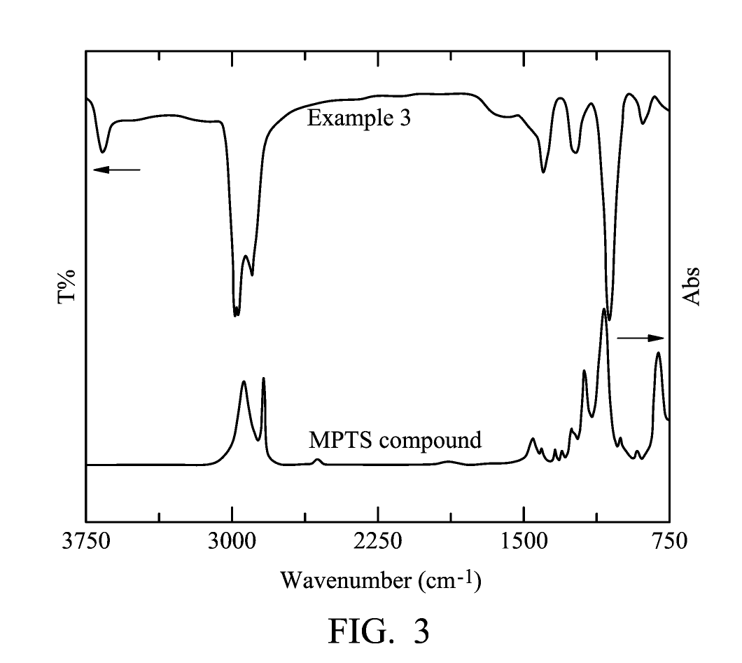

In addition, FIG. 3 shows FTIR spectrums of the surface-modified aluminum oxide membrane of Example 3 and MPTS compound in a KBr solution.

FIG. 3 illustrates that Example 3 had an absorption peak at a position of 1065 cm⁻¹ related to assignment of the O—Si—O of the MPTS. Thus, reaffirming that the MPTS was coated onto the surface of AAOM.

### Efficiency Test for Electroosmosis Pump Using Aluminum Oxide Membrane

FIG. 4 is a schematic diagram of an electroosmosis pump using the aluminum oxide membrane comprising reservoirs 1 and 2, a precision weight balance 3, a power meter 4, a DC power supply 5, Pt conductive lines 6 and 7, and a test section 8. The detailed elements of the test section 8 comprise filter holders 9 and 10, meshed Pt electrodes 11 and 12, and the aluminum oxide membrane 13 disposed between the meshed Pt electrodes 11 and 12 as shown in FIG. 5.

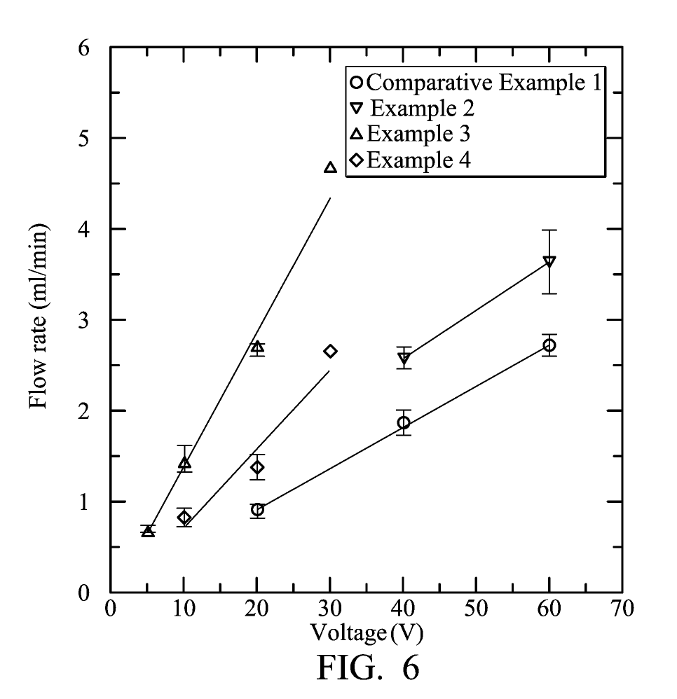

The input voltage and yield flow of the electroosmosis pumps shown as FIG. 5, using the aluminum oxide membranes of the Examples and Comparative example as the membrane 13, were measured. The working parameters and test results are shown in Tables 2 to 4, and FIG. 6.

TABLE 2
electroosmosis pump using membrane of Comparative Example 1

| V (V) | I (A) | Flow rate (ml/min) | Average flow rate (ml/min/V/cm²) | Q (m³/sec) | ΔP (Pa) | $η = \frac{Q \times Δ P}{4 \times V \times I} \times 100 \%$ |
|---|---|---|---|---|---|---|
| 20 | 0.00070 | 0.9157 | 0.042 | 1.53E−08 | 4180 | 0.11392 |
| 40 | 0.00113 | 1.8698 | 0.043 | 3.12E−08 | 6600 | 0.11376 |
| 60 | 0.00145 | 2.7268 | 0.042 | 4.54E−08 | 8130 | 0.10617 |

TABLE 3
electroosmosis pump using membrane of Example 2

| V (V) | I (A) | Flow rate (ml/min) | Average flow rate (ml/min/V/cm²) | Q (m³/sec) | ΔP (Pa) | $η = \frac{Q \times Δ P}{4 \times V \times I} \times 100 \%$ |
|---|---|---|---|---|---|---|
| 5 | 0.000829 | 0.699 | 0.13 | 1.17E−08 | 2350 | 0.165124 |
| 10 | 0.001774 | 1.467 | 0.14 | 2.45E−08 | 4760 | 0.164011 |
| 20 | 0.003629 | 2.666 | 0.12 | 4.44E−08 | 10300 | 0.157641 |
| 30 | 0.006167 | 4.686 | 0.14 | 7.81E−08 | 14500 | 0.153026 |

TABLE 4
electroosmosis pump using membrane of Example 3

| V (V) | I (A) | Flow rate (ml/min) | Average flow rate (ml/min/V/cm²) | Q (m³/sec) | ΔP (Pa) | $η = \frac{Q \times Δ P}{4 \times V \times I} \times 100 \%$ |
|---|---|---|---|---|---|---|
| 10 | 0.00348 | 0.8262 | 0.076 | 1.38E-08 | 2690 | 0.2661 |
| 20 | 0.00650 | 1.3875 | 0.064 | 2.31E-08 | 4470 | 0.19879 |
| 30 | 0.00150 | 2.6646 | 0.082 | 4.44E-08 | 6423 | 0.15847 |

Table 2 lists the experiment results of an electroosmosis pump using the unmodified porous aluminum oxide membrane (Comparative Example 1), showing that the pumping efficiency was about 0.1% and the yield average flow rate per unit voltage and area was about 0.042 ml/min/V/cm². Referring to FIG. 3, with the porous aluminum oxide membrane modified with the APS (Example 2), the pumping efficiency rose to about 0.16%, about 60% higher than the Comparative Example 1, and the yield average flow rate per unit voltage and area was about 0.13 ml/min/V/cm². Referring to FIG. 4, with the porous aluminum oxide membrane modified with the MPTS (Example 3), the pumping efficiency rose to about 0.2%, about 100% higher than the Comparative Example 1, and the yield average flow rate per unit voltage and area was about 0.07 ml/min/V/cm².

FIG. 6 illustrates the relationship between the average flow rate and voltage of electroosmosis pumps. The yield flow rates of the electroosmosis pumps using the porous aluminum oxide membranes modified with H₂O₂ (Example 1), APS (Example 2), and MPTS (Example 3) were higher than the yield flow rate of the pump using the unmodified membrane (Comparative Example 1). Particularly, the flow rate of the electroosmosis pumps using the APS-modified membrane was about two to three times as much as the flow rate of the electroosmosis pump using the unmodified membrane.

### Electric Power Generator Using Aluminum Oxide Membrane

FIG. 7 is a schematic diagram of an electric power generator using the aluminum oxide membrane, comprising reservoirs 1 and 2, Pt conductive lines 6 and 7, a test section 8, a pressure sensor 14, a pressure transmitter 15, a drive pump 16, and a multimeter 17. The detailed elements of the test section 8 comprise filter holders 9 and 10, meshed Pt electrodes 11 and 12, and the aluminum oxide membrane 13 disposed between the meshed Pt electrodes 11 and 12 as shown in FIG. 5. The working efficiency of the electric power generator can be improved when using the surface-modified porous aluminum oxide membrane of the invention as shown in FIG. 5.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for modifying a surface of aluminum oxide, comprising:
making aluminum oxide contact with a hydrogen peroxide aqueous solution having 5-70 volume % of hydrogen peroxide for 20 minutes to 3 hours.

2. The method to modify the surface of the aluminum oxide to as claimed in claim 1, further comprising drying the aluminum oxide.

3. The method to modify the surface of the aluminum oxide to as claimed in claim 2, wherein the drying step is performed at a temperature of 40° C. to 100° C. and a pressure of 10 cmHg to 50 cmHg.

4. The method to modify the surface of the aluminum oxide to as claimed in claim 1, further comprising making the aluminum oxide contact with a 3-aminopropyltriethoxysilane (APS) or 3-Mercaptopropyl trimethoxysilane (MPTS) containing solution after the hydrogen peroxide aqueous solution contact step.

5. The method to modify the surface of the aluminum oxide to as claimed in claim 4, wherein the APS or MPTS containing solution contact step is performed for 1 hour to 12 hours.

6. The method to modify the surface of the aluminum oxide to as claimed in claim 4, wherein a solvent of the APS or MPTS containing solution is acetone.

7. The method to modify the surface of the aluminum oxide to as claimed in claim 6, wherein a volume fraction of APS or MPTS:acetone of the APS or MPTS containing acetone solution is 0.5:60 to 5:100.

8. The method to modify the surface of the aluminum oxide to as claimed in claim 6, wherein the APS or MPTS containing acetone solution contact step is performed for 1 hour to 12 hours.

9. The method to modify the surface of the aluminum oxide to as claimed in claim 6, further comprising making the aluminum oxide contact with a hydrogen peroxide aqueous solution having hydrogen peroxide of 5-70 volume % for over 20 hours after the MPTS containing acetone solution contact step.

10. A method for modifying a surface of aluminum oxide, comprising:
making aluminum oxide contact with a hydrogen peroxide aqueous solution; and
after the hydrogen peroxide aqueous solution contact step, making the aluminum oxide contact with an APS or MPTS containing acetone solution to modify the surface of the aluminum oxide, wherein a contacting time is 1 hour to 12 hours, a volume fraction of APS or MPTS:acetone of the APS or MPTS containing acetone solution is 0.5:60 to 5:100.

11. The method to modify the surface of the aluminum oxide to as claimed in claim 10, wherein the hydrogen peroxide aqueous solution contact step is performed for 20 minutes to 3 hours, and the hydrogen peroxide containing water solution has hydrogen peroxide of 5-70 volume %.

12. The method to modify the surface of the aluminum oxide to as claimed in claim 10, further comprising drying the aluminum oxide after the hydrogen peroxide aqueous solution contact step and before the APS or MPTS containing acetone solution contact step.

13. The method to modify the surface of the aluminum oxide to as claimed in claim 12, wherein the drying step is performed at a temperature of 40° C. to 100° C. and a pressure of 10 cmHg to 50 cmHg.

14. The method to modify the surface of the aluminum oxide to as claimed in claim 10, further comprising drying the aluminum oxide after the APS or MPTS containing acetone solution contact step.

15. The method to modify the surface of the aluminum oxide to as claimed in claim 14, wherein the drying step is performed at a temperature of 40° C. to 100° C. and a pressure of 10 cmHg to 50 cmHg.

16. The method to modify the surface of the aluminum oxide to as claimed in claim 10, further comprising making the aluminum oxide contact with a hydrogen peroxide solution having hydrogen peroxide of 5-70 volume % for over 20 hours after the APS or MPTS containing acetone solution contact step.

17. The method to modify the surface of the aluminum oxide to as claimed in claim 16, further comprising drying the aluminum oxide after the APS or MPTS containing acetone solution contact step and before the hydrogen peroxide aqueous solution contact step.

18. The method to modify the surface of the aluminum oxide to as claimed in claim 17, wherein the drying step is performed at a temperature of 40° C. to 100° C. and a pressure of 10 cmHg to 50 cmHg.

19. An electroosmosis pump, comprising:
a nano-porous aluminum oxide membrane having at least one nano-pore for transferring fluid and modified by the method as claimed in claim 1; and
two electrodes disposed on two opposite sides of the nano-porous aluminum oxide membrane and connected with a power supply for applying potential and causing electroosmotic flow of fluid in the nano-pore of the nano-porous aluminum oxide membrane.

20. The electroosmosis pump as claimed in claim 19, wherein the electrodes are meshed metal.

21. An electric power generator, comprising:
a nano-porous aluminum oxide membrane having at least one nano-pore for a flow channel and modified by the method as claimed in claim 1; and
a fluid supplying system for supplying a fluid flowing through the nano-pore, causing a potential between the two opposite sides of the nano-porous aluminum oxide membrane.
